(19) United States
(12) Patent Application Publication
(10) Pub. No.: US 2022/0241855 A1
(43) Pub. Date: Aug. 4, 2022

(54) ATOMIZATION POWDER MAKING DEVICE

(71) Applicant: METAL INDUSTRIES RESEARCH AND DEVELOPMENT CENTRE, Kaohsiung (TW)

(72) Inventors: Chuan-Jeng HSU, Tainan City (TW); Chung-Jui HUANG, Kaohsiung (TW); Wan-Yun HUANG, Kaohsiung (TW); Chien-Li LAI, Kaohsiung (TW)

(21) Appl. No.: 17/539,718

(22) Filed: Dec. 1, 2021

(30) Foreign Application Priority Data
Jan. 29, 2021 (TW) 110103505

(51) Int. Cl. B22F 9/08

(52) U.S. Cl. CPC B22F 9/082

(57) ABSTRACT

An atomization powder making device suitable for atomizing molten metal to produce powder includes a housing defining an atomizing chamber, a vessel mounted inside the housing and defining a receiving space for receiving the molten metal, and a flow guide unit extending from the bottom of the vessel and having at least one liquid flow channel for conveying the molten metal from the receiving space to the atomizing chamber. A push unit is disposed in the receiving space for pushing the molten metal to flow through the at least one liquid flow channel. A gas supply unit is configured to supply an atomizing gas for atomizing the molten metal flowing out of the liquid flow channel.

### CROSS-REFERENCE TO RELATED APPLICATION

This application claims priority to Taiwanese Patent Application No. 110103505, filed on Jan. 29, 2021.

### FIELD

The disclosure relates to an atomization device, more particularly to an atomization powder making device.

### BACKGROUND

Referring to FIG. 1, a conventional alloy powder making device 1 includes a crucible 11 for receiving molten metal, a conveying tube 12 connected to a bottom portion of the crucible 11 for conveying the molten metal, a heating element 13 surrounding an outer periphery of the conveying tube 12, and a powder spraying unit 14 connected to an outlet of the conveying tube 12. The molten metal is heated by the heating element 13 to form super high-temperature molten metal, is discharged from the conveying tube 12, and is quickly solidified into alloy powder after being impinged and atomized by the powder spraying unit 14.

The conventional alloy powder making device 1 is designed to heat the molten metal twice so as to prevent the molten metal from being easily solidified and blocking the outlet of the conveying tube 12. However, for alloys with high vapor pressures, such as magnesium and zinc, it is easy to generate a large amount of vapor and volatilize during heating, which will affect the subsequent yield. Further, use of the heating element 13 will lead to high cost, and the outlet of the conveying tube 12 is blocked by the disposition of the powder spraying unit 14 and cannot be installed with the heating element 13. That is, the molten metal located in the outlet of the conveying tube 12 cannot be heated, so that the temperature thereof drops rapidly, and may even solidify at the outlet of the conveying tube 12, so that the problem of blockage cannot be solved. An improvement of the conventional alloy powder making device 1 is desired.

### SUMMARY

Therefore, an object of the present disclosure is to provide an atomization powder making device that is capable of alleviating at least one of the drawbacks of the prior art.

Accordingly, an atomization powder making device of this disclosure is suitable for atomizing molten metal to produce powder, and includes a housing defining an atomizing chamber, a vessel mounted inside the housing and located on a top portion thereof, a flow guide unit, a push unit, and a gas supply unit. The vessel has an axis extending in an up-down direction, and defines a receiving space for receiving the molten metal. The flow guide unit extends from the bottom of the vessel along the axis, and has at least one liquid flow channel communicating with the receiving space and the atomizing chamber for conveying the molten metal from the receiving space to the atomizing chamber. The push unit is disposed in the receiving space and is configured to generate a driving force for pushing the molten metal to flow through the at least one liquid flow channel. The gas supply unit is configured to supply an atomizing gas to the atomizing chamber for atomizing the molten metal flowing out of the liquid flow channel.

### BRIEF DESCRIPTION OF THE DRAWINGS

Other features and advantages of the disclosure will become apparent in the following detailed description of the embodiments with reference to the accompanying drawings, of which:

FIG. 1 is a fragmentary perspective view of a conventional alloy powder making device;

FIG. 2 is a schematic sectional side view of an atomization powder making device according to the first embodiment of the present disclosure;

FIG. 3 is an enlarged schematic sectional side view of a push unit and a first alternative form of a flow guide unit of the first embodiment;

FIG. 4 is a top view of a second alternative form of the flow guide unit of the first embodiment;

FIG. 5 is a fragmentary perspective view of the second alternative form of the flow guide unit of the first embodiment;

FIG. 6 is a fragmentary perspective view of a third alternative form of the flow guide unit of the first embodiment;

FIG. 7 is a top view of a fourth alternative form of the flow guide unit of the first embodiment;

FIG. 8 is a fragmentary perspective view of the fourth alternative form of the flow guide unit of the first embodiment;

FIG. 9 is an enlarged schematic sectional side view of a push unit and a flow guide unit of an atomization powder making device according to the second embodiment of the present disclosure;

FIG. 10 is a top view of a push unit of the second embodiment; and

FIG. 11 is an enlarged schematic sectional side view of a push unit and a flow guide unit of an atomization powder making device according to the third embodiment of the present disclosure.

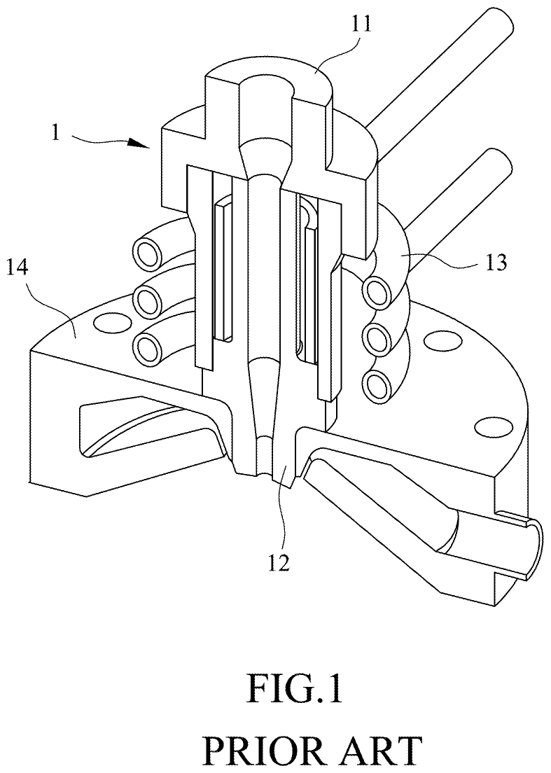

### DETAILED DESCRIPTION

Before the present disclosure is described in greater detail with reference to the accompanying embodiments, it should be noted herein that like elements are denoted by the same reference numerals throughout the disclosure.

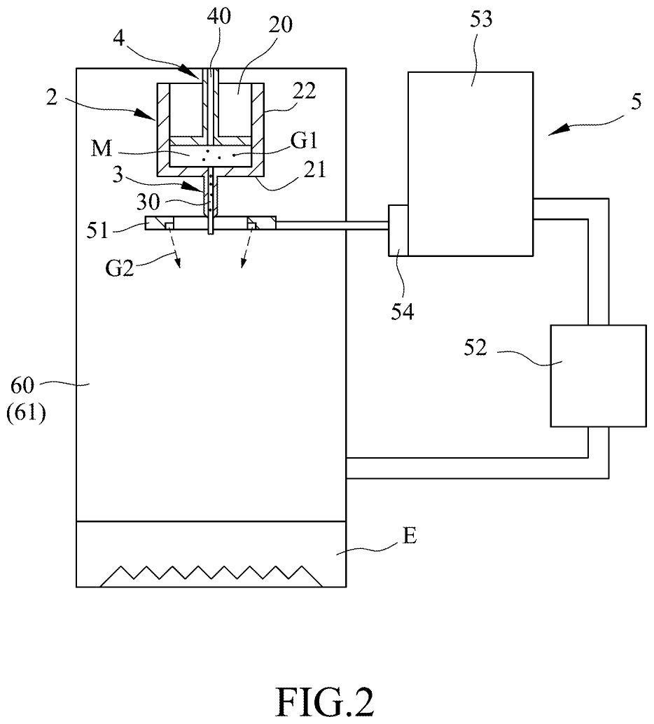

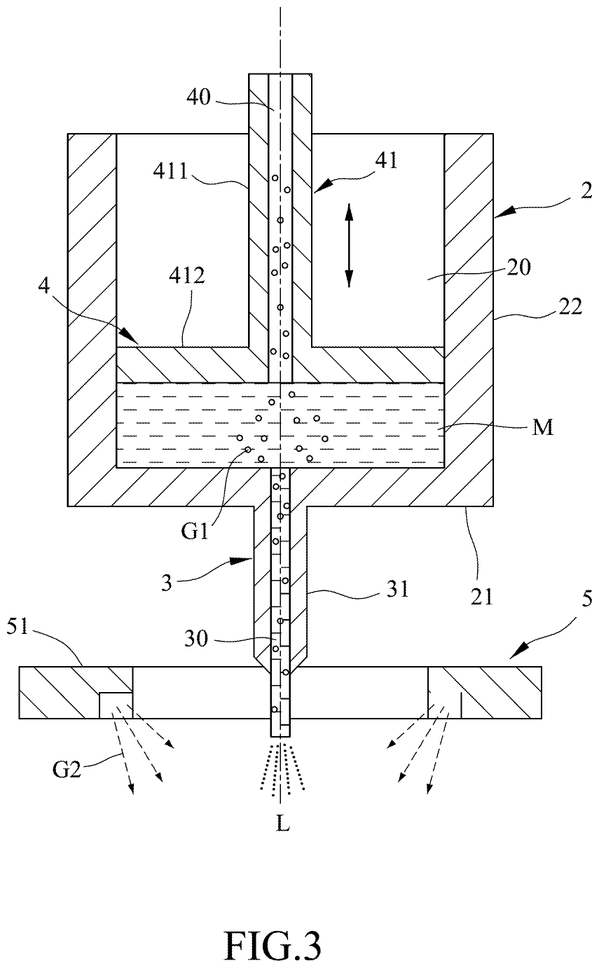

Referring to FIGS. 2 and 3, an atomization powder making device according to the first embodiment of the present disclosure is suitable for atomizing molten metal (M) to produce spherical powder, and includes a housing 60 defining an atomizing chamber 61, a vessel 2, a flow guide unit 3, a push unit 4, and a gas supply unit 5.

The vessel 2 is mounted inside the housing 60 and is located on a top portion thereof. The vessel 2 has a certain degree of mechanical strength and high heat resistance, has a cylindrical shape with an axis (L) extending in an up-down direction, and includes a bottom wall 21, and a surrounding wall 22 extending upwardly from an outer periphery of the bottom wall 21 and cooperating with the bottom wall 21 to define a receiving space 20 for receiving the molten metal (M).

The flow guide unit 3 can be adjusted according to the requirements, and has four alternative forms.

A first alternative form of the flow guide unit 3 is shown in FIGS. 2 and 3. As shown, the flow guide unit 3 includes a flow guide tube 31 extending downwardly from the bottom wall 21 of the vessel 2 along the axis (L) and defining an axially extending liquid flow channel 30 that communicates with the receiving space 20 and the atomizing chamber 61 for conveying the molten metal (M) from the receiving space 20 to the atomizing chamber 61. The flow guide tube 31 has a certain degree of mechanical strength and high heat resistance. The flow guide tube 31 has a columnar shape, but is not limited thereto, and has an inner diameter of 1 to 5 mm, preferably 1 to 2 mm.

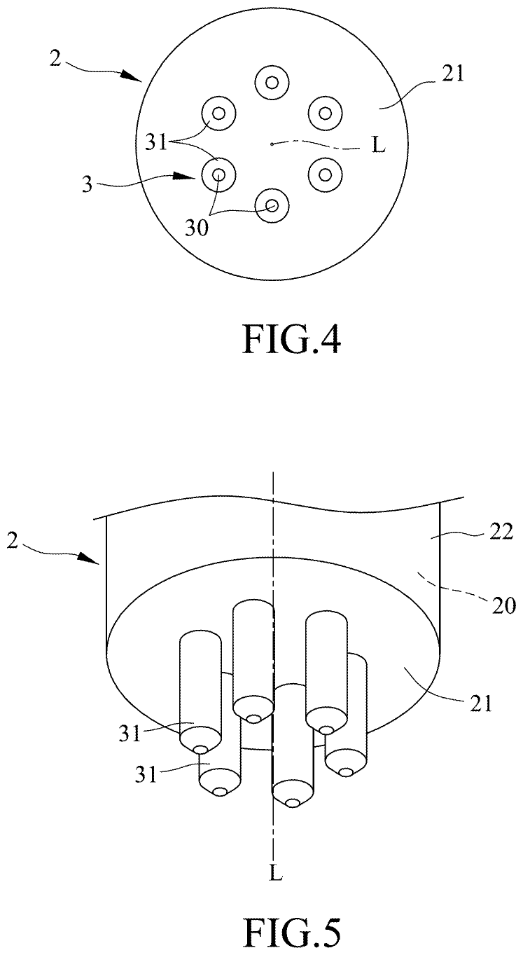

A second alternative form of the flow guide unit 3 is shown in FIGS. 4 and 5. As shown, the flow guide unit 3 includes a plurality of flow guide tubes 31 spaced apart from each other and arranged in a ring shape around the axis (L). Each flow guide tube 31 has a configuration similar to that of the flow guide tube 31 of the first alternative form, and defines an axially extending liquid flow channel 30.

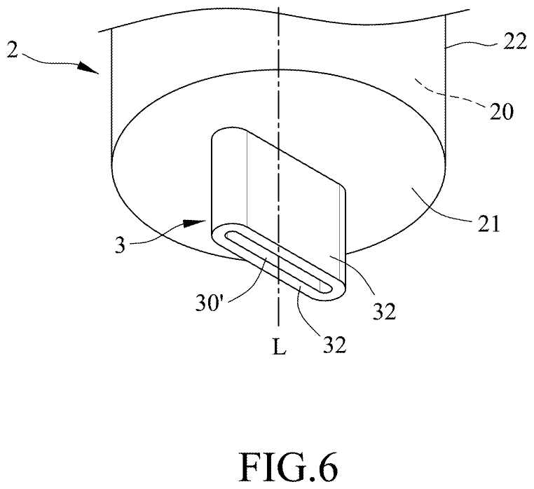

A third alternative form of the flow guide unit 3 is shown in FIG. 6. As shown, the flow guide unit 3 includes two spaced-apart guide plates 32 extending downwardly from the bottom wall 21 of the vessel 2 along the axis (L). The guide plates 32 are flat plates, and are connected to each other to cooperatively define an axially extending liquid flow channel 30′ communicating with the receiving space 20 and the atomizing chamber 61 (see FIG. 2). The guide plates 32 are spaced apart by 1 to 5 mm, preferably 1 to 2 mm.

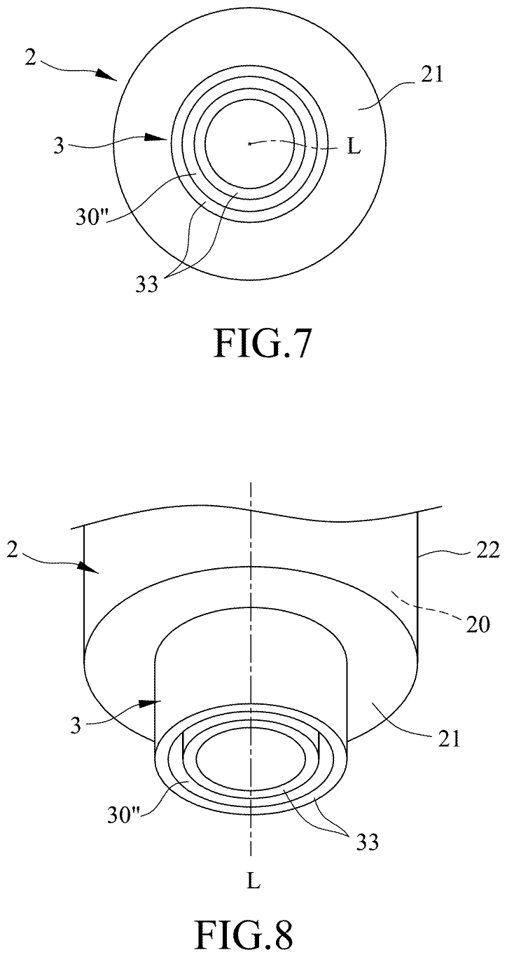

A fourth alternative form of the flow guide unit 3 is shown in FIGS. 7 and 8. As shown, the flow guide unit 3 includes two spaced-apart concentric tubes 33 extending downwardly from the bottom wall 21 of the vessel 2 along the axis (L) and cooperatively defining an axially extending liquid flow channel 30″ communicating with the receiving space 20 and the atomizing chamber 61 (see FIG. 2). The concentric tubes 33 are spaced apart by 1 to 5 mm, preferably 1 to 2 mm.

With reference to FIGS. 2 and 3, the push unit 4 of this embodiment is a thrust piston unit 41 disposed in the receiving space 20 and including a piston shaft 411 that extends along the axis (L) and that defines a gas flow channel 40 for conveying a carrier gas (G1), and a piston 412 connected to and extending outwardly and radially from a bottom periphery of the piston shaft 411. The piston shaft 411 and the piston 412 are movable up and down in the receiving space 20, as shown by an arrow in FIG. 3. The push unit 4 conveys the carrier gas (G1) to the receiving space 20 for mixing the carrier gas (G1) with the molten metal (M). The carrier gas (G1) is an inert gas, and does not chemically react with the molten metal (M). It is worth to mention herein that, in this embodiment, the piston 412 is used to push and squeeze the molten metal (M) toward the bottom wall 21. Through this, a driving force is generated to push the molten metal (M) toward the flow guide tube 31, so that the molten metal (M) can overcome the surface tension generated in the liquid flow channel 30 and can flow through the liquid flow channel 30.

The gas supply unit 5 includes a gas supply 51 disposed below the flow guide tube 31 for supplying an atomizing gas (G2) to the atomizing chamber 61, a blower 52 disposed externally of the housing 60 and fluidly connected to a bottom portion thereof for suctioning the atomizing gas (G2), a gas storage container 53 disposed upstream of and fluidly connected to the blower 52 for storing the atomizing gas (G2) sucked by the blower 52, and a compressor 54 fluidly connected to the gas storage container 53 and the gas supply 51 for compressing the atomizing gas (G2). The atomizing gas (G2) is used for atomizing the molten metal (M) flowing out of the liquid flow channel 30 to produce metal powder and to drive movement of the metal powder. The atomizing gas (G2) is similar to the carrier gas (G1), which is an inert gas, and can be recycled.

The gas supply 51 is configured as an atomizing disc having a central hole surrounding an outlet of the flow guide tube 31. The atomizing gas (G2) produces a gas flow in the atomizing chamber 61 for driving the metal powder to move down rapidly. The pressure of the gas storage container 53 is less than 6 kg/cm², but is not limited thereto. The atomizing gas (G2) can be collected by means of pressure difference. The compressor 54 may be an air compressor, a household pump, a gas supercharger, or a booster valve, but is not limited thereto. As long as the atomizing gas (G2) in the gas storage container 53 can be guided to the gas supply 51 for completing a gas cycle, any type of the compressor 54 is acceptable. In this embodiment, a collection trough (E) is provided at the bottom of the atomizing chamber 61 for collecting the metal powder. It should be noted herein that the sizes and dimensions of the various components of the gas supply unit 5 shown in FIG. 2 are examples only, and are not limited to what is disclosed in this embodiment.

Referring back to FIGS. 2 and 3, since the molten metal (M) flows in the flow guide tube 31 having a small diameter, it will generate a large surface tension and affect the flow stability, which may cause solidification thereof in the flow guide tube 31. Hence, the device of this embodiment is operated after the moving speed of the piston 412 is set according to the flow demand of the molten metal (M), and through the driving force provided by the push unit 4, not only a specific amount of the molten metal (M) can be driven to move toward the liquid flow channel 30, the surface tension generated in the liquid flow channel 30 can also be overcome, so that the molten metal (M) can be quickly discharged from the liquid flow channel 30, thereby preventing the molten metal (M) from solidifying and blocking the flow guide tube 31.

Next, the gas supply 51 is operated to continuously inject the atomizing gas (G2) toward the molten metal (M) flowing out of the liquid flow channel 30 to atomize the molten metal (M) and produce powder as the gas flow moves in the atomizing chamber 61. The powder falls down and is collected in the collection trough (E). Finally, the atomizing gas (G2) is collected in the gas storage container 53 through the blower 52, and is sent back to the gas supply 51 after being compressed by the compressor 54, thereby completing a gas cycle, and the atomizing gas (G2) can be reused.

It should be noted herein that the carrier gas (G1) is introduced into the receiving space 20 through the gas flow channel 40 to mix with the molten metal (M), and the pressure difference formed in the receiving space 20 can force the molten metal (M) to stably flow and increase the speed thereof through the liquid flow channel 30, thereby further preventing the solidification of the molten metal (M) at the outlet of the flow guide tube 31.

Therefore, in the first embodiment, by using the push unit 4 to drive the molten metal (M), not only the amount of the molten metal (M) can be adjusted, but the molten metal (M) can also be made to flow stably and quickly, so that the flow guide tube 31 with a small diameter can be used, thereby refining the molten metal (M). The refined molten metal (M) can produce powder with a small particle size, and only a small amount of the atomizing gas (G2) is necessary to atomize the molten metal (M) and produce powder. Hence, the amount of using the atomizing gas (G2) can be saved, thereby significantly reducing the processing cost. Further, the introduction of the carrier gas (G1) into the receiving space 20 can increase the moving speed of the molten metal (M) through the liquid flow channel 30. The molten metal (M) atomized by the atomizing gas (G2) after flowing out of the liquid flow channel 30 can produce powder having small particle sizes, high uniformity and high quality. It should be noted herein that the total consumption of the carrier gas (G1) and the atomizing gas (G2) is about 20% of the gas consumption required by the traditional atomization powder making device.

Additionally, with reference to FIGS. 4 and 7, with the liquid flow channels 30 of the second alternative form and the liquid flow channel 30″ of the fourth alternative form of the flow guide unit 3 being arranged in a ring shape on the bottom wall 21 of the vessel 2, the efficiency of the carrier gas (G1) to refine the molten metal (M) can be improved.

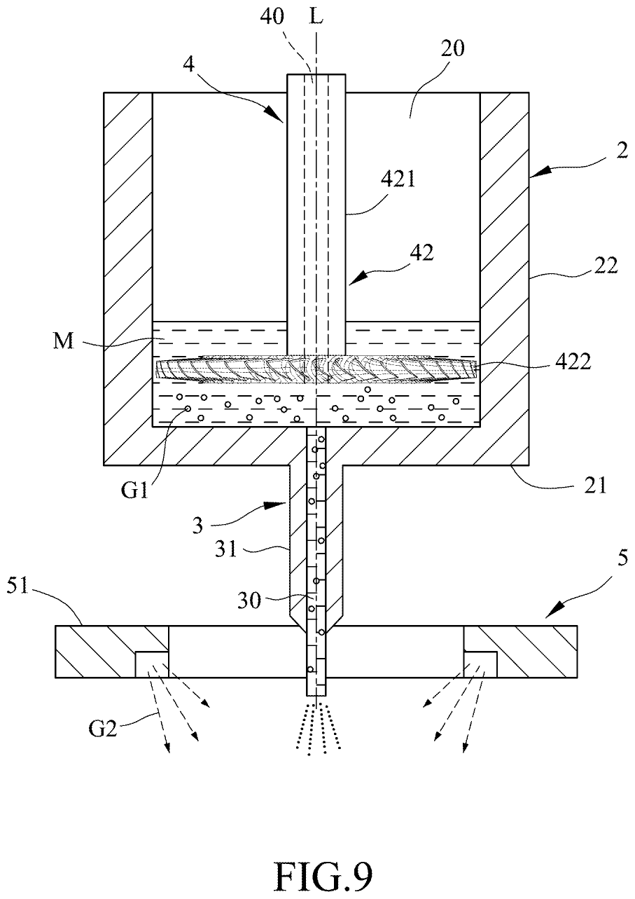

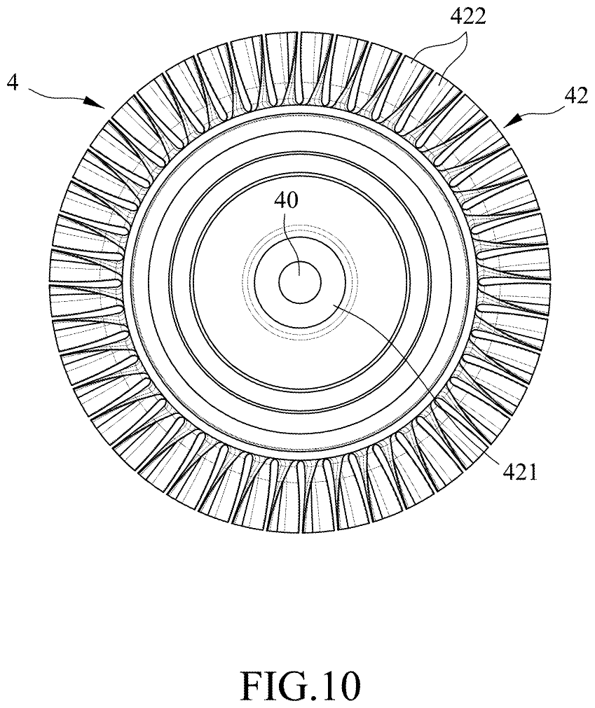

Referring to FIGS. 9 and 10, the second embodiment of the atomization powder making device of this disclosure is suitable for atomizing high silicon aluminum alloy powder with high wear resistance, but is not limited thereto. The second embodiment is similar to the first embodiment, but differs in that the push unit 4 is a turbine thruster 42 made of silicon nitride. The material of the turbine thruster 42 is not limited thereto. The turbine thruster 42 includes a shaft 421 extending along and rotatable about the axis (L), and a plurality of angularly spaced-apart blades 422 connected to and extending outwardly and radially from a bottom periphery of the shaft 421. The shaft 421 is formed with the gas flow channel 40 for conveying the carrier gas (G1), and has a rotational speed of 500 rpm, but is not limited thereto, for driving the blades 422 to rotate at high speed. Through this, the push unit 4 can generate a driving force for pushing the molten metal (M) and the carrier gas (G1) to flow through the liquid flow channel 30 of the flow guide tube 31 of the flow guide unit 3.

In the second embodiment, through the rapid rotation of the push unit 4, a thrust to drive the flow of the molten metal (M) can be generated in order to overcome the surface tension of the molten metal (M) in the flow guide tube 31, so that the molten metal (M) can stably flow through the liquid flow channel 30 having a small inner diameter to achieve refinement. As such, the refined molten metal (M) can produce powder with high uniformity and a small particle size, and only a small amount of the atomizing gas (G2) is used to atomize the molten metal (M) and produce powder. Hence, the amount of using the atomizing gas (G2) can be saved, thereby significantly reducing the processing cost. Further, the carrier gas (G1) is also stirred by the push unit 4 to evenly dispersed in the receiving space 20, and is mixed with the molten metal (M), so that the carrier gas (G1) and the molten metal (M) can flow through the liquid flow channel 30 at a high speed to avoid the problem of the molten metal (M) staying in the flow guide tube 31 for too long which will result in its solidification.

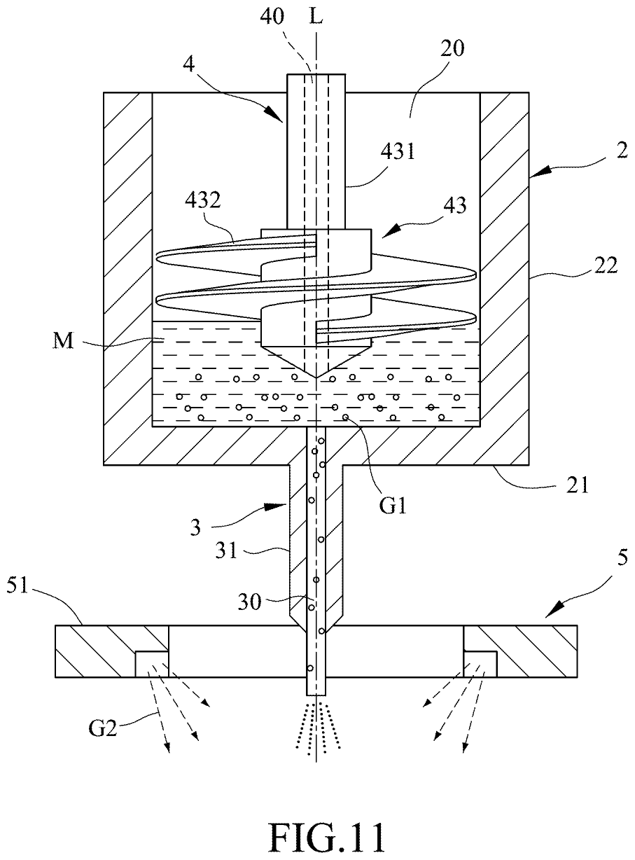

Referring to FIG. 11, the third embodiment of the atomization powder making device of this disclosure is suitable for atomizing magnesium-zinc alloy powder with high vapor pressure, but is not limited thereto. The third embodiment is similar to the second embodiment, but differs in that the push unit 4 is a screw propeller 43 made of stainless steel, but is not limited thereto. The push unit 4 includes a shaft 431 extending along and rotatable about the axis (L), and a spiral blade 432 extending around a bottom portion of the shaft 431. The shaft 431 is formed with the gas flow channel 40 for conveying the carrier gas (G1), and has a rotational speed of 50 rpm, but is not limited thereto, for driving the spiral blade 432 to rotate at high speed, thereby driving the molten metal (M) and the carrier gas (G1) to flow through the liquid flow channel 30 of the flow guide tube 31 of the flow guide unit 3.

The third embodiment not only can achieve the effects of refining the molten metal (M), but also can continuously rotate and agitate the molten metal (M) through the screw propeller 43. Through this, the molten metal (M) can be broken to maintain the fluid properties thereof, thereby further preventing the solidification of the molten metal (M) in the liquid flow channel 30.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An atomization powder making device suitable for atomizing molten metal to produce powder comprising:
a housing defining an atomizing chamber;
a vessel mounted inside said housing and located on a top portion thereof, said vessel having an axis extending in an up-down direction and defining a receiving space for receiving the molten metal;
a flow guide unit extending from the bottom of said vessel along the axis and having at least one liquid flow channel that communicates with said receiving space and said atomizing chamber for conveying the molten metal from said receiving space to said atomizing chamber;
a push unit disposed in said receiving space and configured to generate a driving force for pushing the molten metal to flow through said at least one liquid flow channel; and
a gas supply unit configured to supply an atomizing gas to said atomizing chamber for atomizing the molten metal flowing out of said liquid flow channel.

2. The atomization powder making device as claimed in claim 1, wherein said push unit is a thrust piston unit which is movable up and down in said receiving space and which is suitable for pushing the molten metal to flow through said at least one liquid flow channel.

3. The atomization powder making device as claimed in claim 1, wherein said push unit is a turbine thruster, and includes a shaft extending along and rotatable about the axis, and a plurality of angularly spaced-apart blades connected to and extending outwardly and radially from a bottom periphery of said shaft.

4. The atomization powder making device as claimed in claim 1, wherein said push unit is a screw propeller, and includes a shaft extending along and rotatable about the axis, and a spiral blade extending around a bottom portion of said shaft.

5. The atomization powder making device as claimed in claim 1, wherein said push unit has a gas flow channel for conveying a carrier gas to said receiving space.

6. The atomization powder making device as claimed in claim 1, wherein said flow guide unit includes at least one flow guide tube extending downwardly from the bottom of said vessel and defining said at least one liquid flow channel.

7. The atomization powder making device as claimed in claim 6, wherein said at least one flow guide tube includes a plurality of flow guide tubes spaced apart from each other, said at least one liquid flow channel including a plurality of liquid flow channels, each of said flow guide tubes defining a respective one of said liquid flow channels, each of said flow guide tubes having an inner diameter of 1 to 5 mm.

8. The atomization powder making device as claimed in claim 7, wherein said flow guide tubes are arranged in a ring shape around the axis.

9. The atomization powder making device as claimed in claim 1, wherein said flow guide unit includes two spaced-apart guide plates extending downwardly from the bottom of said vessel and cooperatively defining said at least one liquid flow channel, said guide plates being spaced apart by 1 to 5 mm.

10. The atomization powder making device as claimed in claim 1, wherein said flow guide unit includes two spaced-apart concentric tubes extending downwardly from the bottom of said vessel and cooperatively defining said at least one liquid flow channel.

11. The atomization powder making device as claimed in claim 1, wherein said gas supply unit includes a gas supply disposed below said flow guide unit for supplying the atomizing gas to said atomizing chamber, and a blower disposed externally of said housing and fluidly connected to a bottom portion of said housing for suctioning the atomizing gas.

12. The atomization powder making device as claimed in claim 11, wherein said gas supply unit further includes a gas storage container fluidly connected to said blower for storing the atomizing gas sucked by said blower, and a compressor fluidly connected to said gas storage container and said gas supply for compressing the atomizing gas.
